(19) United States
(12) Patent Application Publication
(10) Pub. No.: US 2014/0078635 A1
(43) Pub. Date: Mar. 20, 2014

(54) INTEGRATED SURGE PROTECTION FOR REMOTE RADIO HEAD POWER CABLE ASSEMBLIES

(71) Applicants: Mark Edward Conner, Granite Falls, NC (US); Tory Allen Klavuhn, Newton, NC (US)

(72) Inventors: Mark Edward Conner, Granite Falls, NC (US); Tory Allen Klavuhn, Newton, NC (US)

(21) Appl. No.: 13/837,678

(22) Filed: Mar. 15, 2013

Related U.S. Application Data
(60) Provisional application No. 61/703,032, filed on Sep. 19, 2012.

(51) Int. Cl. H02H 9/04

(52) U.S. Cl. CPC H02H 9/04
USPC 361/119

(57) ABSTRACT

A surge protection apparatus for a power cable assembly is disclosed. The surge protection apparatus is located in-line with the power cable and may be integrated into or be a separate component from the power cable assembly and provide surge protection without the need to locate a surge protection device in a terminal. In this way, the terminal remains small and lightweight while the surge protection can be provided as needed. The apparatus may be used for power-only assemblies as well as hybrid power/fiber assemblies.

### CROSS-REFERENCE TO RELATED APPLICATIONS

This application claims the benefit of priority under 35 U.S.C. §119 of U.S. Provisional Patent Application No. 61/703,032, filed Sep. 19, 2012, the content of which is relied upon and incorporated herein by reference in their entirety.

### BACKGROUND

1. Field of the Disclosure

The technology of the disclosure relates to power cable assemblies for providing electrical power to remote radio heads and more particularly to a surge protection apparatus for power cable assemblies.

2. Technical Background

Fiber to the Antenna (FTTA) solutions using remote radio head (RRH) technology either have surge protection built into the RRH or require it externally. In some cases, a wireless service provider (WSP) will want additional surge protection beyond what is built into the devices. A terminal can become bulky with surge protection mounted in it. Larger terminals often mean a higher monthly lease expense for that item on a tower.

### SUMMARY

Embodiments disclosed in the detailed description includes an apparatus and method of having an integrated surge protection and/or a separate surge protection component to provide surge protection for an RRH without the need to locate a surge protection device in a terminal. In this way, the terminal remains small and lightweight while the surge protection can be provided as needed. The apparatus and method could be used for power-only assemblies as well as hybrid power/fiber assemblies.

Aspects of the embodiments may include a remote radio cable assembly (RRCA) for power having a surge protection device integrated in either the cable or the connectors on at least one end of the RRCA. Aspects of the embodiments may also include a discrete device inserted in the power circuit, as a nonlimiting example by plugging it into the edge power connector on the RRH. The power RRCA may then be connected to this device and routed back to be plugged into the power terminal.

In one embodiment, a remote radio cable assembly includes a power cable including a power input connector. A power output connector connects to a remote radio head. A surge protection device is connected to and in-line with the power cable and is located between the power input connector and the power output connector.

In another embodiment, a fiber to antenna assembly includes a remote radio head operably connected to a base station terminal. A remote radio cable assembly delivers power to the remote radio head. The remote radio cable assembly includes a power cable including a power input connector, a power output connector that is connected to the remote radio head and a surge protection device that is external to the remote radio head. The surge protection device is connected to and in-line with the power cable and is located between the power input connector and the power output connector.

In another embodiment, a method of supplying power to a remote radio head using a remote radio cable assembly is provided. The method includes connecting a power input connector of the remote radio cable assembly to a source of power. A power output connector is connected to the remote radio head. The remote radio cable assembly is protected from power surges using a surge protection device located between the power input connector and the power output connector.

Additional features and advantages are set out in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic illustration of an embodiment of a remote radio cable assembly with surge protection;

FIG. 2 is a schematic illustration of another embodiment of a remote radio cable assembly with surge protection;

FIG. 3 is a schematic illustration of another embodiment of a remote radio cable assembly with surge protection;

FIG. 4 is a schematic illustration of a fiber to antenna assembly including a remote radio cable assembly with surge protection;

FIG. 5 is another schematic illustration of a fiber to antenna assembly including a remote cable assembly with surge protection;

FIG. 6 is another schematic illustration of a fiber to antenna assembly including a remote cable assembly with surge protection;

FIG. 7 is a schematic illustration of an embodiment of a remote radio cable assembly with surge protection;

FIG. 8 is a schematic illustration of another embodiment of a remote radio cable assembly with surge protection;

FIG. 9 is a schematic illustration of a fiber to antenna assembly including a remote radio cable assembly with surge protection;

FIG. 10 is a schematic illustration of a fiber to antenna assembly including a remote radio cable assembly with surge protection;

FIG. 11 is a schematic illustration of a fiber to antenna assembly including a remote radio cable assembly with surge protection;

FIG. 12 schematically illustrates an exemplary attachment arrangement for a surge protection device; and

FIG. 13 is a front view of the attachment arrangement of FIG. 12.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Whenever possible, like reference numbers will be used to refer to like components or parts.

As used herein, it is intended that terms “fiber optic cables” and/or “optical fibers” include all types of single mode and multi-mode light waveguides, including one or more optical fibers that may be up-coated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals.

As used herein, it is intended that terms “electrical power cable” and/or “electrical conductor” include all types of cables and/or conductors used to transmit electrical power manufactured of any conductive material, including without limitation, copper and aluminum and in any form, including without limitation, multiple or individual conductors and whether jacketed, armored, and/or the like.

Embodiments disclosed in the detailed description include an apparatus and method of having an integrated surge protection or a separate surge protection component or device to provide surge protection without the need of locating a surge protection device in a terminal. In this way, the terminal remains small and lightweight while the surge protection can be provided as needed. The apparatus and method could be used for power-only assemblies as well as hybrid power/fiber assemblies.

Aspects of the embodiments may include a remote radio cable assembly (RRCA) for power having a surge protection device integrated in either the power cable or the connectors on at least one end of the RRCA, such that the surge protection device is in-line with the power cable. Aspects of the embodiments may also include a discrete device inserted in the power circuit, as a nonlimiting example by plugging it into the edge power connector on the RRH. Alternatively, the power cable may be blunt ended and inserted into the RRH with the insulation stripped back and the conductors secured to a terminal block by screws. The power RRCA may then be connected to this device and routed back to be plugged into the power terminal.

Referring to FIG. 1, an exemplary RRCA 10 may be referred to as a “dongle-type” RRCA and includes a power output connector 12 (e.g., an RRH connector) for connecting to an RRH, a power input connector 14 for connecting to a terminal and/or power tether, as examples, and a surge protection device 16 located in-line with the power cable 20 between the power output connector 12 and the power input connector 14. Although not shown in FIG. 1, the power cable may be blunt ended and inserted into the RRH with the insulation stripped back and the conductors secured to a terminal block by screws. The power output connector 12 may be connected to a housing 18 of the surge protection device 16 (e.g., releasably or permanently). Any suitable method can be used to connect the power output connector 12 to the housing 18, such as fasteners, welding, adhesives and the like. The power output connector 12 is connected directly to the housing 18 (i.e., no cable is located between the power output connector 12 and the housing 18). In some embodiments, the power output connector 12 may be rigidly connected to the housing 18 such that the surge protection device 16 and the power output connector 12 move together, instead of capable of movement relative to each other.

The power input connector 14 is connected to the housing 18 (e.g., releasably or permanently) using a power cable 20. In this instance, the power input connector 14 is indirectly connected to the housing 18 via the power cable 20. Due to the flexibility of the power cable 20, the power input connector 14 can move relative to the housing 18, for example, to facilitate a connection to a terminal and/or power tether.

The RRCA 10 may further include a ground connector 22. The ground connector 22 may connect to a ground bar or other ground structure. The ground connector 22 may also be indirectly connected to the housing 18 (e.g., releasably or permanently) via a ground wire 24. Due to flexibility of the ground wire 24, the ground connector 14 can move relative to the housing 18, for example, to facilitate a connection to the ground bar.

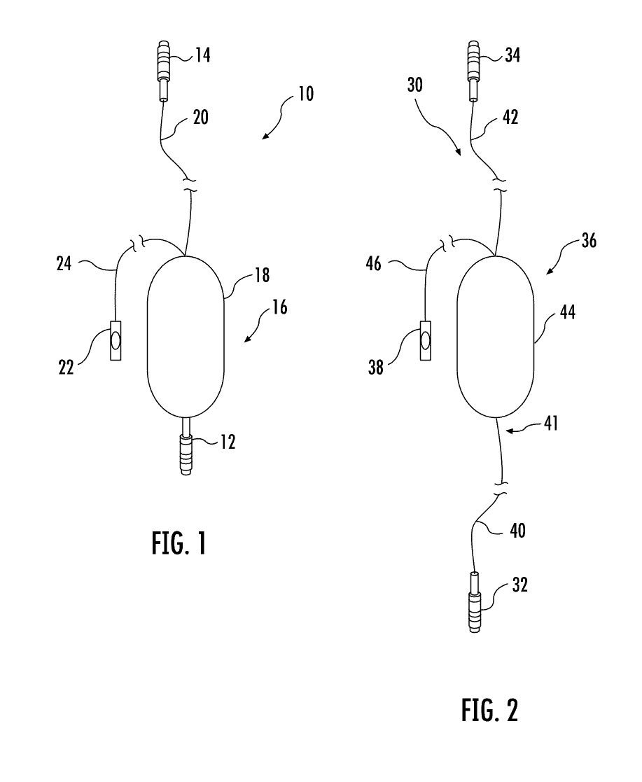

Referring to FIG. 2, another exemplary RRCA 30 includes many of the components of RRCA 10 including a power output connector 32 for connecting to an RRH, a power input connector 34 for connecting to a terminal and/or a power tether, a surge protection device 36 and a ground connector 38 for connecting to a ground bar. Located between the power output connector 32 and the power input connector 34 is the surge protection device 36. In this embodiment, however, the surge protection device 36 is located in-line with the power cable 41 and between first and second power cable segments 40 and 42. The power output connector 32 is connected to a housing 44 of the surge protection device 36 via first power cable 40. Thus, the power output connector 32 is indirectly connected to the housing 44 (e.g., releasably or permanently). Due to the flexibility of the first power cable 40, the power input connector 34 can move relative to the housing 44, for example, to facilitate a connection to an RRH.

The power input connector 34 is connected to the housing 44 using the second power cable 42. In this instance, the power input connector 34 is indirectly connected to the housing 44 via the cable 42 (releasably or permanently). Due to the flexibility of the second cable 42, the power input connector 34 can move relative to the housing 44, for example, to facilitate a connection to a terminal and/or power tether.

The RRCA 30 may further include the ground connector 38. The ground connector 38 may connect to a ground bar. The ground connector 38 may also be indirectly connected to the housing 44 via a ground wire 46 (e.g., releasably or permanently). Due to flexibility of the ground wire 46, the ground connector 38 can move relative to the housing 44, for example, to facilitate a connection to the ground bar or other ground structure.

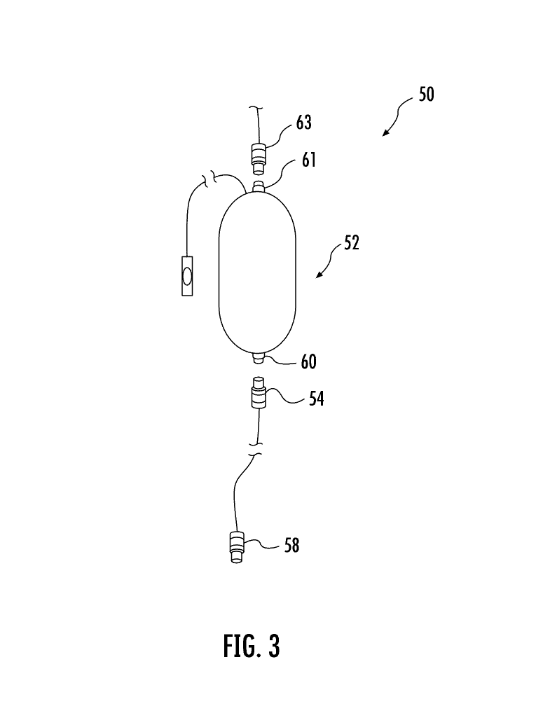

Referring to FIG. 3, another exemplary RRCA 50 is releasably connectable to a surge protection device 52. In this embodiment, the RRCA 50 includes a surge protection device (SPD) connector 54 for releasably connecting to the surge protection device 52 and a power input connector 58 for connecting to a terminal and/or power tether. In this embodiment, the surge protection device 52 includes an RRCA connector 60 compatible with the SPD connector 54 of the RRCA 50 and a RRH connector 61 comparable with a SPD connector 63 of the RRH. In some embodiments, the SPD connector 54 may also be a power output connector so that the RRCA 50 may be connected to the RRH directly, e.g., without use of the surge protection device 52. Such an arrangement can allow for temporary removal of the surge protection device 52, if needed, for example, for repair with minimal disruption of operation of the RRH.

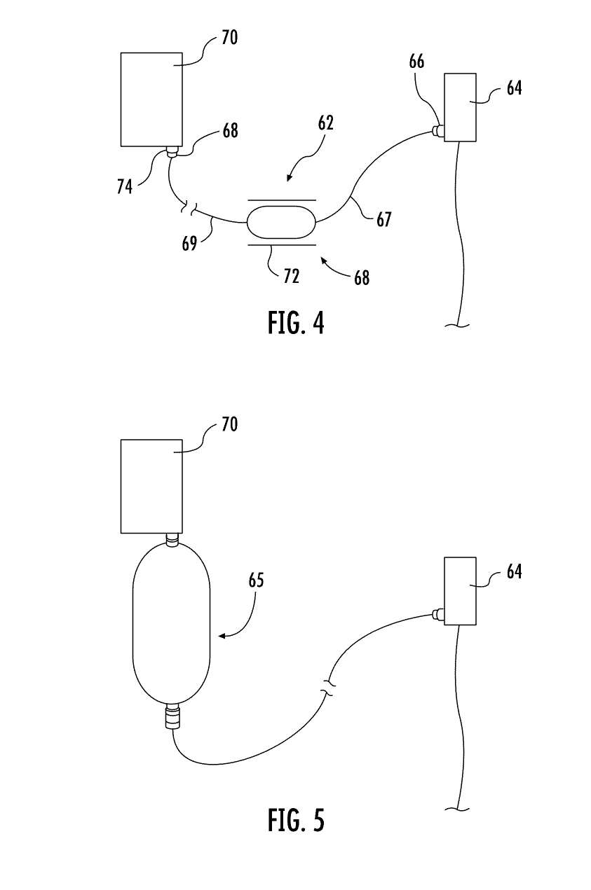

FIGS. 4 and 5 illustrate two ways of providing surge protection external to the RRH. Referring first to FIG. 5, a surge protection device 65 may be used as a separate component, in a fashion similar to that described with reference to FIG. 3. FIG. 4 illustrates a surge protection device 62 in-line and integrated into power cable 68 as one assembly in a fashion similar to that of FIG. 2. In this way, the surge protection devices 65 and 62 do not have to be located or integrated into a terminal 64, the arrangement of which can have two down sides: 1) the terminal gets bigger, and 2) the terminal must have more than one size housing available to manufacture terminals with and without surge protection. Alternatively, everything may be built into one size larger housing, which is not ideal as it would result in higher installation and lease cost.

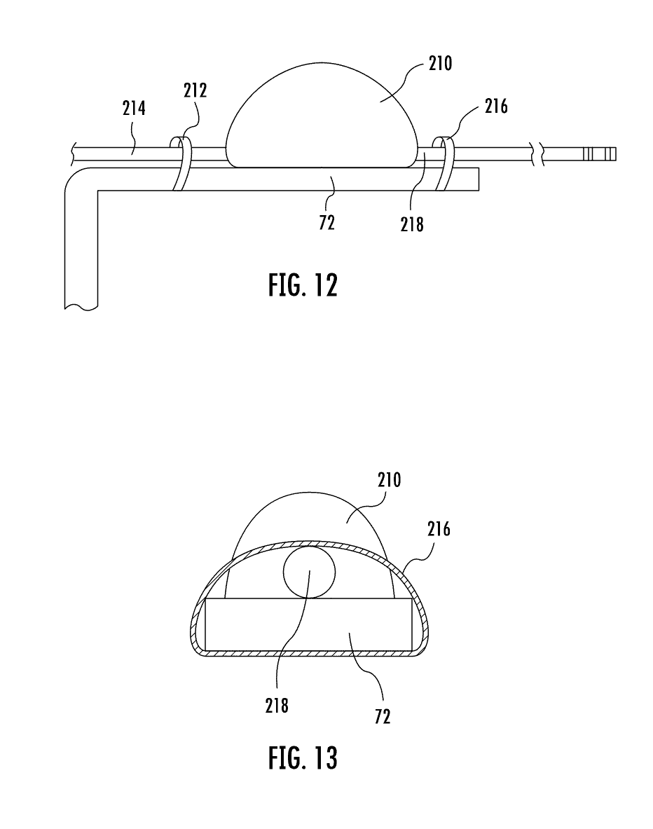

The integrated surge protection device 62 as illustrated in FIG. 4 may be arranged so that the surge protection device 62 has a power cable segment 67 with power input connector 66 on one side and a relatively short (for example 12 inches) power cable segment 69 with power output connector 68 that plugs into an RRH 70. The surge protection device 62 can thus be attached to a tower structure 72 (see FIGS. 12 and 13) using the additional slack provided by the power cables 67 and 69, rather than hang from an RRH power port 74. Power may be supplied to the surge protection device 62 from a breakout point and/or the terminal 64 using the power cable 67. The advantages of this arrangement are flexibility of mounting position and support, ruggedness, and avoidance of being bumped and vibrated. Additionally, the surge protection device 62 may be designed with one input connector which matches the one on the RRH allowing the surge protection device 62 to be an “insertable” element that can be used in line if needed or omitted when not required.

Although not shown in FIGS. 4 and 5, the surge protection apparatus may be used with break-out tethers, as a non-limiting example, a tether from a FlexNAP™ System as provided by Corning Cable System LLP of Hickory, N.C. The integrated surge protection devices may have a male connection on one end and female connection on the opposite end. This allows the surge protection devices to be mounted in the RRH's power port while accepting the standard RRH power connector as feed.

A ground wire may be required in the RRCA. A monitoring connection may be required at the RRH. A monitoring connection may be required at the terminal, which will be described in greater detail below. Both power-only and hybrid power/fiber assemblies may be outfitted with integrated surge protection devices.

Additionally or alternatively, surge protection may be integrated into the edge connectors either at the RRH or at the terminal remotely. Addressable surge protection devices or circuit breakers may be included. Remotely monitored devices and those not remotely monitored may be included. The surge protection device may also serve as a breakout point from a hybrid cable a power cable and/or connector with a fiber cable/connector to plug into the RRH.

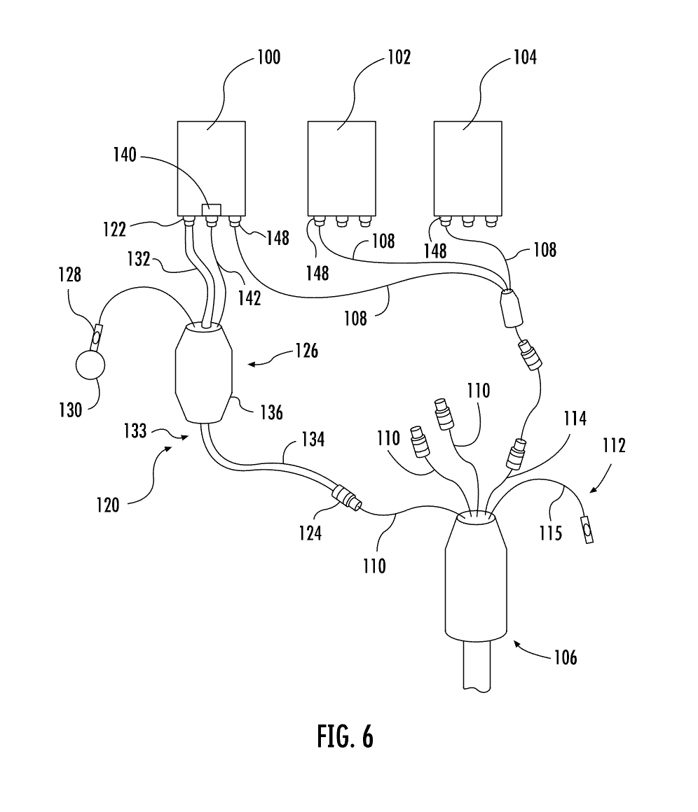

Referring now to FIG. 6, a method of providing power to multiple RRHs 100, 102 and 104 is illustrated. In this embodiment, a hybrid cable 106 comprising both optical fibers 108 and one or more power tethers 110 extends from a base station terminal (not shown). A break-out location 112 is provided in the hybrid cable 106 where, for example, a multi-fiber cable 114 (or multiple multi-fiber cables) and the power tethers 110 break away from the hybrid cable 106 to facilitate connection to the RRHs 100, 102 and 104. A ground wire 115 may also break away from the hybrid cable 106 at the break-out location 112.

An RRCA 120 includes a power output connector 122 for connecting to the RRH 100, a power input connector 124 for connecting to the power tether 110, a surge protection device 126 and a ground connector 128 for connecting to a ground bar 130. While only one RRCA is illustrated as connecting to the RRH 100 for clarity, multiple RRCAs may be provided for connecting to the multiple RRHs. Located between the power output connector 122 and the power input connector 124 is the surge protection device 126. In this embodiment, the surge protection device 126 is located in-line with power cable 133 between first and second power cable segments 132 and 134. The power output connector 122 is connected to a housing 136 of the surge protection device 126 via first power cable 132 segment. Thus, the power output connector 122 is indirectly connected to the housing 136 to facilitate the connection to the RRH 100. The power input connector 124 is connected to the housing 136 using the second power cable 134 segment. In this instance, the power input connector 124 is indirectly connected to the housing 136 via the second cable segment 134 to facilitate a connection to the power tether 110. Both or either of the first and second power cable segments 132 and 134 can be integral or permanently connected and/or releasably connected to the housing 136.

In some embodiments, a monitoring device 140 may be provided for monitoring operation of the surge protection device 126. The monitoring device 140 may include one or more sensors that can be used to detect improper operation of the surge protection device 126. A monitoring cable 142 may be provided that provides signals to the monitoring device 140. In the illustrated embodiment, the monitoring device 140 may be provided as part of the RRH 100. In other embodiments, the monitoring device 140 may be provided as part of the surge protection device 126 or as a separate component.

The multi-fiber cable 114 may include multiple optical fibers 108. The optical fibers 108 may include optical fiber connectors 148 for connecting with optical fiber connectors 150 of the RRHs 100, 102 and 104.

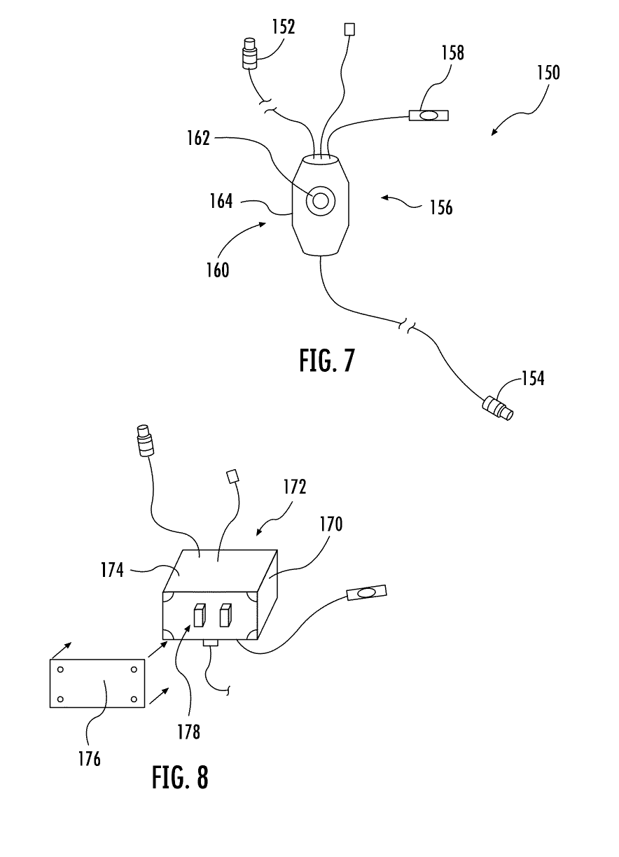

Referring to FIG. 7, an RRCA 150 includes many of the components discussed above including a power output connector 152 for connecting to an RRH, a power input connector 154 for connecting to a power tether or terminal, a surge protection device 156 and a ground connector 158 for connecting to a ground structure. In this embodiment, a monitoring device 160 includes a visual status indicator 162 that is visible from outside housing 164. The visual status indicator 162 may provide an indication (light, sound, etc.) when the surge protection device is not operating properly and has an out-of-parameter condition.

The housings described above may be formed using any suitable process. For example, housings for the surge protection devices may be formed by over molding the surge protections components with a plastic material. The housing may have some flexibility or may be rigid. Referring to FIG. 8, a housing 170 of a surge protection device 172 may be formed as a box-like structure having multiple walls 174. A removable access door 176 may be provided for allowing access to electrical components 178 of the surge protection device 172.

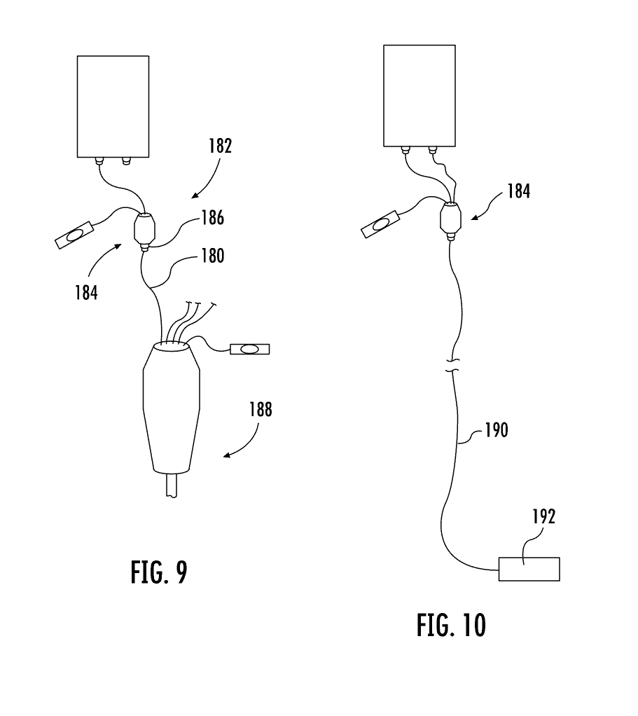

Referring to FIG. 9, in some embodiments, a power tether 180, itself, may form part of a RRCA 182 by providing a power cable. In this embodiment, a surge protection device 184 may include an input connector 186 that operatively receives the power tether 180 directly from a hybrid cable 188. Referring to FIG. 10, in some embodiments, the surge protection device 184 may receive a power line 190 having a length sufficient to run from a base station terminal 192 to be connected to the surge protection device 184.

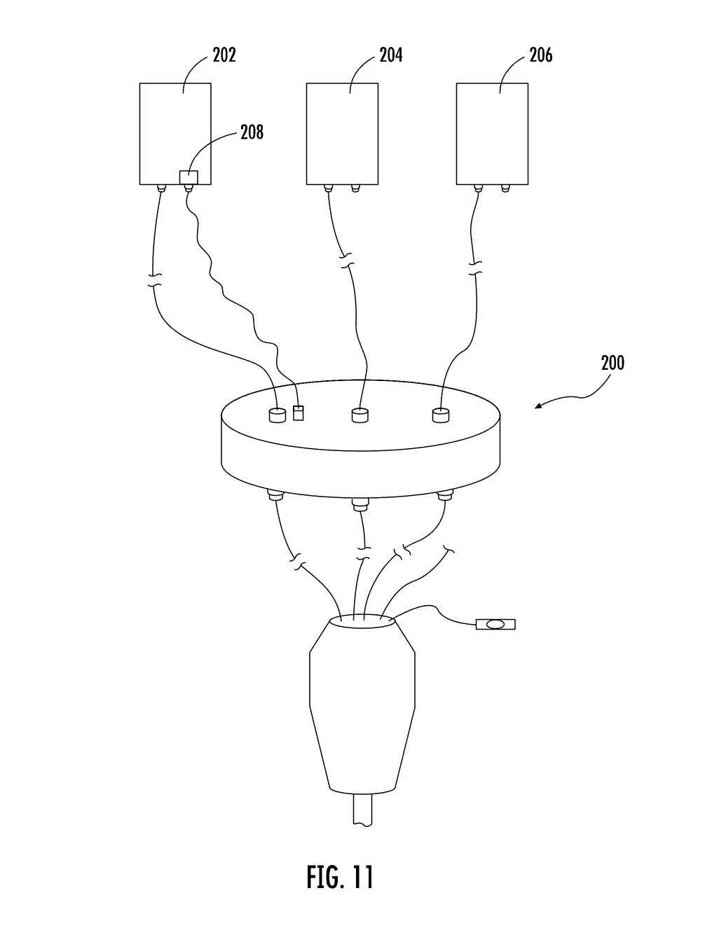

While the surge protection devices described above are illustrated as servicing a single RRH, referring to FIG. 11, a single surge protection device 200 may be used to service multiple RRHs 202, 204 and 206. A single (or multiple) monitoring device 208 may be used to monitor the surge protection device 200 for all of the RRHs 202, 204 and 206.

Referring to FIGS. 12 and 13, an exemplary attachment arrangement is illustrated where a surge protection device 210 is attached to an antenna structure 72. In this embodiment, a clamp, tie, rope, wire or other attachment 212 is wrapped about a first power cable segment 214. A second attachment 216 is wrapped about a second power cable segment 218 that can be attached to an RRH. In some embodiments, a connector may be wrapped about the surge protection device 210 itself. Any suitable attachment arrangement may be used to attach the surge protection device 210 to the antenna structure 72.

The above-described surge protection devices may include a housing that is sealed to the environment. The seal may be permanent and the housing not enterable, the seal may be temporary and the housing enterable and re-enterable. In some embodiments, the housing may be re-sealed once entered. Connectorized inputs and/or outputs and/or terminal-block style inputs and/or outputs may be provided for the various connections. In particular, while connectors may be used to interface between the surge protection device and the RRH and terminal, connectors may not be used. Instead, the power cables may be blunt ended and the conductors stripped and inserted into a terminal block and, for example, secured by a screw or other fastener providing a more permanent connection.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A remote radio cable assembly comprising:
a power cable including a power input connector;
a power output connector that connects to a remote radio head; and
a surge protection device connected to and in-line with the power cable and located between the power input connector and the power output connector.

2. The remote radio cable assembly of claim 1, wherein the power cable includes a first power cable segment including a power input connector, the power cable further comprising a second power cable segment connected to the surge protection device and the power output connector.

3. The remote radio cable assembly of claim 1, wherein the surge protection device comprises a housing.

4. The remote radio cable assembly of claim 3, wherein the housing is a molded structure.

5. The remote radio cable assembly of claim 3, wherein the power output connector is connected directly to the housing.

6. The remote radio cable assembly of claim 1 further comprising a ground connector connected to the surge protection device by a ground wire.

7. The remote radio cable assembly of claim 1, wherein the surge protection device comprises a visual status indicator that provides an indication when the surge protection device has an out-of-parameter condition.

8. The remote radio cable assembly of claim 1, wherein the surge protection device includes a monitoring cable configured to provide signals to a monitoring device for monitoring operation of the surge protection device.

9. A fiber to antenna assembly comprising:
a remote radio head operably connected to a base station terminal; and
a remote radio cable assembly that delivers power to the remote radio head, the remote radio cable assembly comprising:
a power cable including a power input connector;
a power output connector that is connected to the remote radio head; and
a surge protection device external to the remote radio head, the surge protection device being connected to and in-line with the power cable and located between the power input connector and the power output connector.

10. The fiber to antenna assembly of claim 9 further comprising a terminal that provides a power source, the power input connector being connected to the terminal.

11. The fiber to antenna assembly of claim 9 further comprising a power tether, the power input connector being connected to the power tether.

12. The fiber to antenna assembly of claim 11, wherein the power tether is part of a hybrid cable operably connected to a base station terminal.

13. The fiber to antenna assembly of claim 12, wherein the hybrid cable comprises an optical fiber that connects to the remote radio head and delivers signals between the remote radio head and the base station terminal.

14. The fiber to antenna assembly of claim 9, wherein the power cable of the remote radio cable assembly includes a first power cable segment including a power input connector, the power cable further comprising a second power cable segment connected to the surge protection device and the power output connector.

15. The fiber to antenna assembly of claim 9, wherein the surge protection device comprises a housing.

16. The fiber to antenna assembly of claim 15, wherein the housing is a molded structure.

17. The fiber to antenna assembly of claim 15, wherein the power output connector is connected directly to the housing.

18. The fiber to antenna assembly of claim 9, wherein the remote radio cable assembly further comprises a ground connector connected to the surge protection device by a ground wire.

19. The fiber to antenna assembly of claim 9, wherein the surge protection device comprises a visual status indicator that provides an indication when the surge protection device has an out-of-parameter condition.

20. The fiber to antenna assembly of claim 1, wherein the surge protection device includes a monitoring cable configured to provide signals to a monitoring device for monitoring operation of the surge protection device.

21. The fiber to antenna assembly of claim 20, wherein the remote radio head comprises a monitoring device connected to the monitoring cable.

22. A method of supplying power to a remote radio head using a remote radio cable assembly, the method comprising:
connecting a power input connector of the remote radio cable assembly to a source of power;
connecting a power output connector to the remote radio head; and
protecting the remote radio cable assembly from power surges using a surge protection device located between the power input connector and the power output connector.

23. The method of claim 22, wherein the remote radio cable assembly comprises a power cable connected to the power input connector.

24. The method of claim 23, wherein the power cable comprises a first power cable segment, the power cable further comprising a second power cable segment connected to the surge protection device and the power output connector.
